(19) United States
(12) Patent Application Publication
(10) Pub. No.: US 2012/0128988 A1
(43) Pub. Date: May 24, 2012

(54) ELECTRIC MOTOR INSULATING SHEET AND A MANUFACTURING METHOD THEREFOR

(75) Inventors: Miyoshi Yokura, Yokkaichi (JP); Hisashi Katsumata, Yokkaichi (JP); Masashi Kato, Yokkaichi (JP)

(73) Assignee: KAWAMURA SANGYO CO., LTD., Mie-ken (JP)

(21) Appl. No.: 13/379,611

(22) PCT Filed: Jun. 11, 2010
(86) PCT No.: PCT/JP2010/059929

§ 371 Date: Feb. 8, 2012

(30) Foreign Application Priority Data
Jun. 22, 2009 (JP) 2009-147582

(51) Int. Cl. B32B 27/08; B32B 29/00

(52) U.S. Cl. 428/419; 428/473.5; 428/474.4; 428/474.7; 156/272.6

(57) ABSTRACT

An insulation sheet for electric machine that forms slot insulation sheet is configured by an aramid paper and a PPS film directly pressure laminated without use of an adhesive. This means that no adhesive layer interposes the aramid paper and PPS film. PPS film is less costly as compared to a polyimide film and possesses better thermal properties such as higher heat emissivity and is highly resistant to heat. Thus, high strength is maintained even when subjected to high temperature over extensive time. Further, because the aramid paper and PPS film are laminated directly without an adhesive layer, the laminate is reduced in thickness. This allows further thinning of the laminate.

### TECHNICAL FIELD

The present invention relates to an insulation sheet for electric machines such as motors and power generators and more specifically to an insulation sheet, for electric machines providing advantageous mechanical properties, heat resistance, electric insulation, and chemical resistance and a method of manufacturing such insulation sheet.

### BACKGROUND

As hybrid and electric automobiles become more popular, nigh powered, electric machines with smaller size are developed. The electric machines employed in such hybrid and electric automobile applications employ an insulation sheet that insulate the core and coil wound around it. One example of insulation sheet used in electric machines is a heat resistant synthetic insulation sheet called aramid paper. Namely, aromatic series based polyamide sheet (Product name: Nomex (registered trademark; #410, Nomex #411) of Du Pont is known that is 2 to 20 mil thick and exhibits advantageous heat resistance, mechanical properties, and electric insulation. The aramid paper is used as an insulation material for transformers, motors, and power generators that are categorized under I.E.C 85 (1984) and class H (180° C.) thermal class.

Low cost, polyester based film (hereinafter referred to as PET based film) such as polyethylene terephthalate and polyethylene naphthalate are less heat, resistant as compared to an aramid paper and are categorized under I.E.C 85 (1984) and class E (120 degrees Celsius) thermal class. Thus, these PET based films are not suitable for hybrid and electric automobile applications.

The following F class (155° C.) insulation materials (A) to (C) have been proposed that do not require the level of heat resistance required in class H.

(A) A multilayered insulation material given by bonding an aramid paper advantageous in heat resistance and a PET based film advantageous in oxidation resistance with an adhesive to obtain the combined advantages of the two materials.

(B) An insulation material made of a laminate of an aramid paper and a PET based film which are thermally pressure bonded at high temperature and pressure. The insulation material is an aramid laminate obtained by thermally bonding an m-aramid paper and a biaxial stretched PET film which is heated in a temperature ranging between 220 to 250° C. and a linear pressure of 50 kg/cm or greater.

(C) A laminate of an aramid paper layer (A layer) made of aramid fiber and aramid pulp and PET film. The aramid paper layer having PET welded or impregnanted at or above the melting temperature to its surface is superimposed with PET film and thereafter welded at a roll temperature ranging between 220 to 250° C. and pressure of 50 kg/cm or greater to be further quenched at a speed of 100° C./minute or greater to obtain the laminate.

However, insulating material (A) obtained by bonding aramid paper and PET based film with an adhesive is disadvantageous in that the adhesive is relatively hard. Thus, the outstanding bendability of the aramid paper and PET based film is lost, resulting in poor processability in a bending process, for example. Further when material (A) is applied to machinery containing oil such a lubricant oil, the components of the adhesive may dissolve in the oil and thus, being limited in its application. Further, because the layer of adhesive is several μm to several tens of μm thick, the sheet becomes thicker and prevents the downsizing of electric machines.

In contrast, materials (B) and (C) are laminates of the aramid paper and the PET based film bonded by thermal welding without an adhesive. Thus, materials (B) and (C) solve the disadvantages which arise from the use of adhesive. However, because the temperature of thermal welding in material (B) approximates the melting temperature of PET (approximately 260° C.), PET film suffers a significant deformation. Consequently, material (B) is subjected to warpage, shrinkage, creasing and partial crystallization of PET. Thus, it is difficult to obtain high quality product through material (B) on a regular basis. The temperature of thermal welding in material (C) is also high as was the case in (B). Thus, material (C) also looses its bendability by the crystallization of some of PET impregnanted into the aramid paper.

Aramid paper and polyimide film being laminated by special adhesive has been proposed that meets class H (180° C.) requirements of I.E.C standards. However, a polyimide film as well as the laminate of the aramid paper and polyimide film is expensive. Thus, the laminate of aramid paper and polyimide film has not been employed in mass production hybrid and electric automobiles.

Accordingly, achieving heat resistance and heat emissivity as well as durability is difficult without increase in cost. Further, increase in thickness and degradation in bendability and thermal properties hamper the increase in the number of winding turns and thus, preventing further improvement in the performance of electric machines.

### SUMMARY OF THE INVENTION

### Problem to be Overcome

It is thus, an object of the invention to provide an insulation sheet that allows downsizing and performance improvement of electric machines by obtaining the desired thermal properties as well as durability at low cost, and a method of manufacturing such insulation sheet.

An insulation sheet for an electric machine according to the present invention provides insulation between a core of the electric machine and a winding and comprises an aramid paper configured as a sheet primarily comprising aramid fibrid and short fiber; an aromatic polymer film that is formed into a sheet comprising one or more selected from a group of poly phenylene sulfide, polyimide, polyether ether ketone, polyether imide, and para-based aromatic polyamide and that is directly pressure laminated with the aramid paper.

According to the above described configuration, the insulation sheet for electric machines of the present invention is configured such that the aramid paper and the aromatic polymer film are directly pressure laminated without an adhesive. This means that no adhesive layer interposes the aramid paper and the aromatic polymer film. The aromatic polymer film is less costly as compared to a polyimide film and possesses better thermal properties such as higher heat emissivity and is highly resistant to heat. Thus, high strength is maintained even when subjected to high temperature over extensive time. Further, because the aramid paper and aromatic polymer film are laminated directly without an adhesive layer, the laminate is reduced in thickness. This allows further thinning of the laminate. As a result, the number of winding turns of coil is increased without increasing the size of the electric machine. Further, reduced thickness improves the thermal conductivity to facilitate emission of heat from the windings. Thus, downsizing and performance improvement of electric machines are achieved while obtaining the desired thermal properties as well as durability at low cost.

Further, the insulation sheet for electric machines of the present invention has aramid paper laminated on both sides of the aromatic polymer film. The aramid paper and the aromatic polymer film are in direct lamination. Thus, increase in the overall thickness of the laminate can be prevented even if the aramid paper is laminated on both sides of the aromatic polymer film. Thus, further downsizing and performance improvement of electric machines can be achieved.

Further, the insulation sheet for electric machines of the present invention employs poly phenylene sulfide (PPS) film as the aromatic polymer film. PPS is highly thermally resistant and mechanically strong. Thus, high strength is maintained even when reduced in thickness. As a result, electric machines can be made more durable while achieving downsizing and performance improvement.

A method of manufacturing an insulation sheet for electric machines according to the present invention comprises preparing an aramid paper formed into a sheet primarily comprising aramid fibrid and short fiber and an aromatic polymer film formed into a sheet comprising one or more selected from a group of poly phenylene sulfide, polyimide, polyether ether ketone, polyether imide, and para-based aromatic polyamide; plasma treating a surface of at least one of the aramid paper and the aromatic polymer film; and pressure bonding the aramid paper and the aromatic polymer film at the plasma treated surface.

The method of manufacturing the insulation sheet for electric machines according to the present invention performs plasma treatment on the surface of at least either of the aramid paper and the aromatic polymer film. The plasma treated surface serves as a bonding surface on which the aramid sheet and aromatic polymer film are pressure bonded. Thus, the aramid paper and the aromatic polymer film can be bonded without an adhesive by plasma treating of the surface of either of the aramid paper and the aromatic polymer film. As a result, the adhesive layer can be eliminated to allow a thinner laminate. Thus, downsizing and performance improvement of electric machines are achieved while obtaining the desired thermal properties as well as durability at low cost.

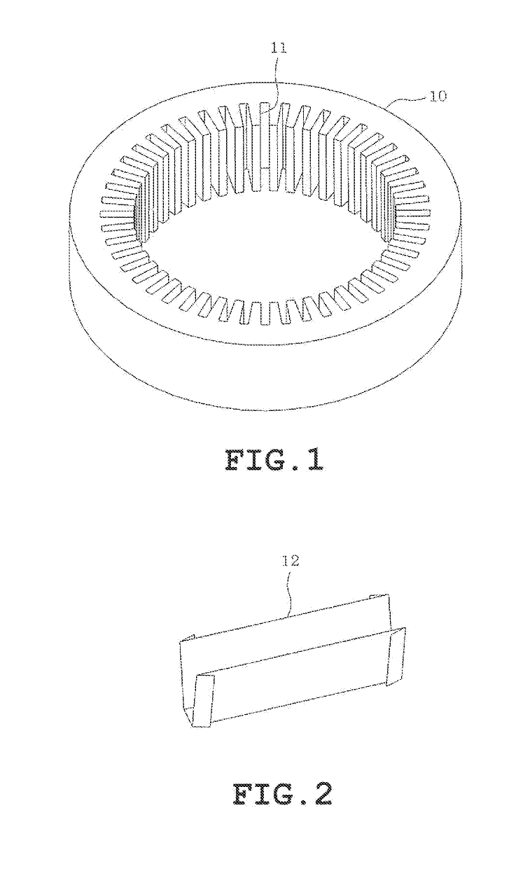

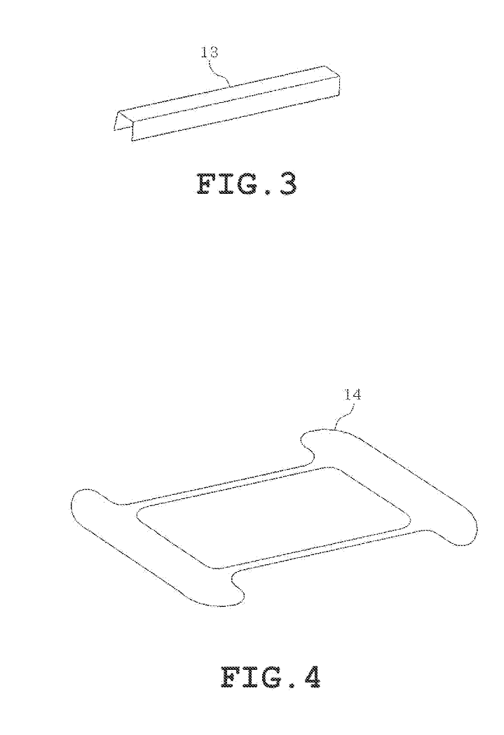

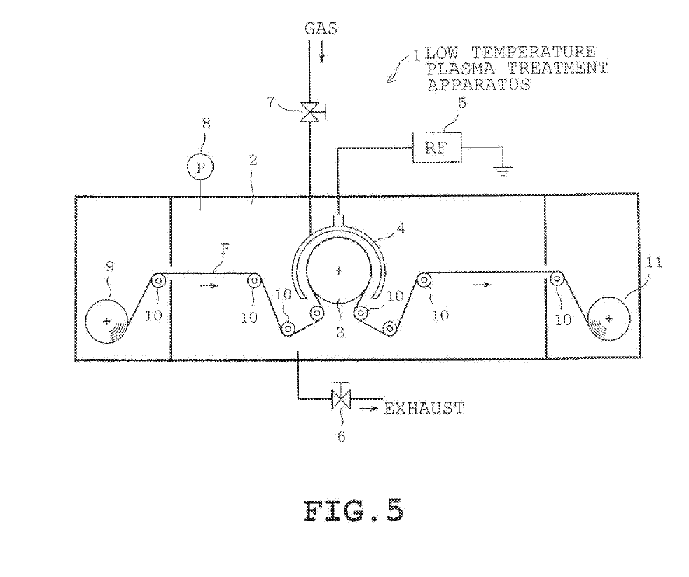

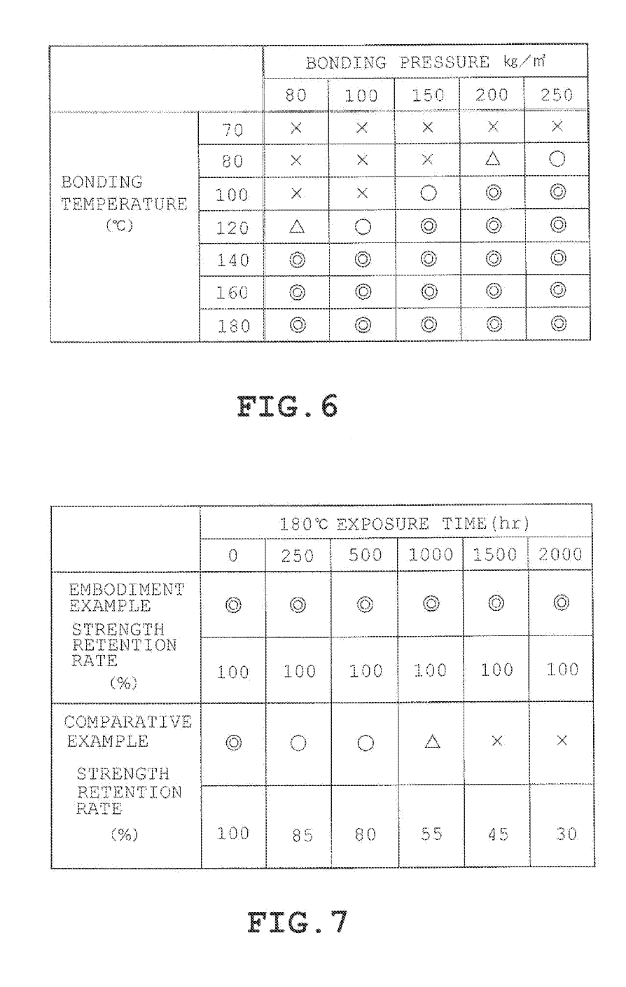

### BRIEF DESCRIPTION OF THE DRAWINGS

[FIG. 1] A general perspective view of a core of an electric machine to which an insulation sheet for electric machines is applied according to one embodiment.

[FIG. 2] A general perspective view of a slot insulation sheet comprising the insulation sheet for electric machines according to one embodiment.

[FIG. 3] A general perspective view of a wedge comprising the insulation sheet for electric machines according to one embodiment.

[FIG. 4] A general perspective view of an inner insulating sheet comprising the insulation sheet for electric machines according to one embodiment.

[FIG. 5] A vertical cross sectional view generally illustrating a configuration of a low-temperature plasma treatment apparatus according to one embodiment.

[FIG. 6] A chart indicating the relation of the bonding temperature/pressure and the bonding strength of the insulation sheet for electric machines according to one embodiment.

[FIG. 7] A chart indicating the result of comparative experiment of the insulation sheet for electric machines and a commercially available comparative example in terms of heat resistance according to one embodiment,

### EMBODIMENTS OF THE INVENTION

A description will be given on the embodiments based on the drawings.

Insulation sheet for electric machines according to one embodiment is an aramid paper-aromatic polymer film laminate. The aramid paper-aromatic polymer film laminate comprises an aramid paper and an aromatic polymer film thermally bonded directly without a bonding agent.

The insulation sheet for electric machines is used to provide insulation between core 10 and a winding of an electric machine used in hybrid automobiles and electric automobiles as shown in FIG. 1. Core 10 of the electric machine is provided with radially oriented protrusion and retractions on its inner peripheral side and winding is wound around each of the plurality of protrusions 11 protruding toward the inner peripheral side. In order to provide insulation between the winding and protrusion 11 of core 10, slot, insulation sheet 12 made of the insulation sheet for electric machines shown in FIG. 2 is inserted between protrusion 11 of core 10 and the winding.

More specifically, slot insulation sheet 12 is inserted between protrusions 11 of core 10 shown in FIG. 1. After inserting slot insulation sheet 12, winding is wound with slot insulation sheet 12 inserted between protrusions 11. Core 10 of the electric machine further has wedge 13 shown in FIG. 3 and inner insulating sheet 14 shown in FIG. 4 inserted or installed to it. Slot insulation sheet 12, wedge 13, and inner insulating sheet 14 all comprise the insulation sheet for electric machines of the present embodiment. Thus, the insulation sheet for electric machines that constitute slot insulation sheet 12, wedge 13, and inner insulating sheet 14 not only requires high insulation but also high heat resistance, and heat conductivity to transfer the heat produced at the winding toward core 10. Because slot insulation sheet 12 is interposed between core 10 and the winding, it is preferable to make slot insulation sheet 12 as thin as possible. Thinner slot insulation sheet 12 allows greater spacing between protrusions 11 neighboring each other in the circumferential direction of core 10, meaning that greater space is available for the winding. As a result, in case the distance between protrusions 11 of core 10, in other words, the volume of the space between protrusions 11 is unchanged, the number of winding turns can be increased, whereas when the number of winding turns is unchanged, the volume of the space between protrusions 11 of core 10 can be reduced. The same is applicable to wedge 13 and inner insulating sheet 14. Thus, the thinned insulation sheet for electric machines allows downsizing and increase in the output of electric machines at the same time.

Next, a description will be given in more detail on the insulation sheet for electric machines.

The aramid paper is formed into a sheet primarily made of fibrid and short fiber comprising poly-m-phenyleneiso-phthalamide (m-aramid). The aramid paper has its surface treated by low temperature plasma and is given a capability of direct thermal bonding with aromatic polymer film.

More specifically, the aramid paper employed in the present embodiment is commercially available and is 5 mil (“1 mil” is 1/1000 of an inch) thick. The aramid paper is commercially available under the product name “Nomex” produced by Du Pont Teijin Advanced Paper Ltd. The aromatic polymer film employed in the present embodiment comprises a commercially available PPS film which is 50 μm thick. The PPS film is commercially available under the product name “TORELINA”.

The surface of aramid paper for bonding with PPS film is subjected to low-temperature plasma treatment using low-temperature plasma treatment apparatus 1 employing an internal electrode system shown in FIG. 5 with customized parameters such as intensity of treatment. In this case, the intensity of low-temperature plasma treatment apparatus 1 ranges between 30 W·min/m² and 1500 W·min/m². In the present embodiment, the ratio X (O/C) of atoms in the bonding surface of the aramid paper is 0.31.

Low-temperature plasma treatment apparatus 1 shown in FIG. 5 is provided with a scalable processing chamber 2. Processing chamber 2 contains processing roller 3 and electrode 4 surrounding processing roller 3 with a small spacing therebetween. Electrode 4 is connected to high-frequency power supply 5 and processing roller 3 is grounded. The interior of processing chamber 2 is reduced in pressure by opening valve 6 connected to a vacuum pump, while accepting supply of processing gas to the processing portion, where discharge takes place, by opening valve 7 connected to a gas supply source. Examples of processing gases used are argon and nitrogen. Pressure inside processing chamber 2 is measured through pressure gauge 8 provided with it.

A roll of untreated aramid paper F is unrolled from supplier 9 and guided by guide rollers 10 provided within processing chamber 2 to be wound almost once, for example, around processing roller 3. Aramid paper F is thus, passed through the processing portion between processing roller 3 and electrode 4. Aramid paper F, after being plasma treated at the processing portion, is guided by guide roller 10 to be rewound by winder 11. Low-temperature plasma treatment is performed on the bonding surface of aramid paper F. Thus, when bonding PPS film on both sides of aramid paper F, plasma treatment is performed on both sides of aramid paper F. When bonding PPS film only on one side of aramid paper F, plasma treatment is performed only on one side of aramid paper F on which PPS is to be bonded.

PPS film bonded to aramid paper F is also subjected to surface treatment for enhanced adhesiveness. The foregoing low-temperature plasma treatment is performed on PPS film using low-temperature plasma treatment apparatus 1. The plasma treated aramid paper and the PPS film are thermally bonded directly to be formed into the insulation sheet for electric machines. Thermal bonding is performed by a thermal press in which a laminate of the aramid paper and the PPS resin film is placed between heated plates, for example, and pressed for 10 minutes (pressure 20 kg/cm²). Then, pressure is released and the bonded insulation sheet for electric machines is collected and left to cool to room temperature.

Next, a description will be given on the relation between the bonding temperature, bonding pressure, and bonding strength based on FIG. 6.

In FIG. 6, symbol “⊚” indicates an “optimal” state in which the bonding strength is extremely high; “◯”indicates a “suitable” state in which the bonding strength is high; “Δ” indicates a state in which the bonding strength is “acceptable” which is lower than “◯: high”; and “X” indicates a state in which the bonding strength is insufficient and thus, “inacceptable”. To qualify as a product, “◯: high” or higher grade is preferable. FIG. 6 verifies the relation between temperature and pressure when thermally bonding the plasma treated aramid paper and PPS film. It can be observed from FIG. 6 that bonding strength improves with increase in bonding temperature and bonding pressure. Thus, insulation sheet for electric machines can obtain sufficient bonding strength by optimal selection of bonding temperature and bonding pressure.

Next, the result of comparative experiment in terms of heat resistances between an embodiment example of the insulation sheet for electric machines versus a comparative example available in the market is indicated in FIG. 7.

Both the embodiment example and the comparative example are formed by bonding aramid papers on both sides of PPS film. The comparative example differs from the embodiment example in that it is a commercially available laminate of aramid paper and PPS film bonded with an adhesive. This means that an adhesive layer interposes the aramid paper and the PPS film. An adhesive that bonds the aramid paper and the PPS film with a high bonding force and that is highly resistant to heat is yet to be developed. Thus, the laminate of commercially available aramid paper and PPS film is inferior to the embodiment example in terms of thermal properties and endurance and is also thicker.

FIG. 7 indicates the retention rate of tensile strength observed after the embodiment example of the insulation sheet for electric machines and the laminate of comparative example were placed in a heating oven set to 180° C. for a predetermined period of time. The retention rate of tensile strength indicates the relative tensile strength after predetermined time period when the tensile strength of the initial state prior to the placement into the oven is represented as 100%. In FIG. 7, “⊚” indicates that the tensile strength retention rate is “100%”; “◯” indicates that the tensile strength retention rate is “80% or more”; “Δ” indicates that the tensile strength retention rate is “50% or more”; and “X” indicates that the tensile strength retention rate is “less than 50%”. The numerical values given in FIG. 7 represent the tensile strength retention rate (%).

As can be observed from FIG. 7, the embodiment example of insulation sheet for electric machines maintains tensile strength retention rate 100% even after being exposed in 180° C. atmosphere for more than 2000 hours. This means that the embodiment example of insulation sheet for electric machines maintains sufficient tensile strength retention rate even after being exposed in 180° C. atmosphere for more than 2000 hours. The laminate of comparative example, on the other hand, reduces its tensile strength retention rate as the time of exposure to the 180° C. atmosphere increases. More specifically, the comparative example reduces its tensile strength retention rate to 85% after 250 hours and to 30% after 2000 hours.

Hybrid and electric automobiles application requires the tensile strength retention rate to be maintained for 2000 hours or more in the exposure of the 180° C. atmosphere. In case this requirement is not met, a long term use of the electric machine may cause insulation breakdown or performance degradation of the electric machine.

As shown in FIG. 7, the embodiment example of insulation sheet for electric machines retains sufficient tensile strength even after 2000 hours. Thus, the embodiment example of insulation sheet for electric machines meets the requirements of hybrid and electric automobile applications. In contrast, the laminate of the comparative example shows a clear progression of degradation and the tensile strength retention rate is reduced to 50% or lower after 2000 hours. Thus, the application of the laminate of the comparative example to electric machines for hybrid and electric automobiles is impractical.

As described above, the performance of insulation sheet for electric machines of the present embodiment is sufficient for hybrid and electric automobile applications. The insulation sheet for electric machines in the present embodiment is configured by an aramid paper and a PPS film directly pressure laminated without a bonding agent. This means that no bonding agent layer interposes the aramid paper and the PPS film. The polymer film is less expensive as compared to PPS film and possesses better thermal properties such as higher heat emissivity and is highly resistant to heat. Thus, high strength is maintained even when subjected to high temperature over extensive time. Further, because the aramid paper and PPS film are laminated directly without an adhesive layer, the laminate is reduced in thickness. This allows further thinning of the laminate. As a result, the number of winding turns is increased without increasing the size of the electric machine. Further, reduced thickness improves the thermal conductivity to facilitate emission of heat from the windings. Thus, downsizing and performance improvement of electric machines are achieved while obtaining the desired thermal properties as well as durability at low cost.

Further, the insulation sheet for electric machines of the present invention has aramid papers laminated on both sides of EPS film. The aramid paper and PPS film are in direct lamination. Thus, increase in the overall thickness of the laminate can be prevented even if the aramid paper is laminated on both sides of the aromatic polymer film. Thus, further downsizing and performance improvement of electric machines can be achieved.

Further, the insulation sheet for electric machines of the present invention employs poly phenylene sulfide (PPS) film as the aromatic polymer film. PPS is highly thermally resistive and mechanically strong. Thus, high strength is maintained even when reduced in thickness. As a result, the electric machine can be made more durable while achieving downsizing and performance improvement.

Plasma treatment is performed on the surface of at least either of the aramid paper and PPS film of the insulation sheet for electric machines according to the present invention. The plasma treated surface serves as a bonding surface on which the aramid sheet and PPS film are pressure bonded. Thus, the aramid paper and PPS film can be bonded without an adhesive by plasma treating the surface of either of the aramid paper and PPS film. As a result, the adhesive layer can be eliminated to render a thinner laminate. Thus, downsizing and performance improvement of electric machines are achieved while obtaining the desired thermal properties as well as durability at low cost.

In the embodiment described above, PPS film was employed as an example of an aromatic polymer film. However, the aromatic polymer is not limited to PPS but may also employ polyether ether ketone, polyimide, polyether imide, and para-based aromatic polyamide, etc. as the insulation sheet for electric machines.

### DESCRIPTION OF REFERENCE SYMBOLS

In the figures, reference symbol 1 represents a low-temperature plasma treatment apparatus; 2, a processing chamber; 3, a processing roller; 4, an electrode; F, an aramid sheet.

1. An insulation sheet for an electric machine that provides insulation between a core of the electric machine and a winding, comprising:
an aramid paper configured as a sheet primarily comprising aramid fibrid and aramid short fiber;
an aromatic polymer film that is formed into a sheet comprising one or more selected from a group of poly phenylene sulfide, polyimide, polyether ether ketone, polyether imide, and para-based aromatic polyamide and that is directly pressure laminated with the aramid paper.

2. The insulation sheet for the electric machine according to claim 1, wherein the aramid paper is laminated on both sides of the aromatic polymer film.

3. The insulation sheet for the electric machine according to claim 1, wherein the aromatic polymer film comprises poly phenylene sulfide.

4. A method of manufacturing an insulation sheet for a electric machine, comprising:
preparing an aramid paper formed into a sheet primarily comprising aramid fibrid and aramid short fiber and an aromatic polymer film formed into a sheet comprising one or more selected from a group of poly phenylene sulfide, polyimide, polyether ether ketone, polyether imide, and para-based aromatic polyamide;
plasma treating a surface of at least one of the aramid paper and the aromatic polymer film; and
pressure bonding the aramid paper and the aromatic polymer film at the plasma treated surface.

5. The method of manufacturing the insulation sheet for the electric machine according to claim 4, wherein the aromatic polymer film comprises poly phenylene sulfide.

6. The insulation sheet for the electric machine according to claim 2, wherein the aromatic polymer film comprises poly phenylene sulfide.
